(19) United States
(12) Patent Application Publication
(10) Pub. No.: US 2004/0104898 A1
(43) Pub. Date: Jun. 3, 2004

(54) Means for handhold functional apparatus

(76) Inventor: Ziad Badarneh, Oslo (NO)

Correspondence Address: RODMAN RODMAN, 7 SOUTH BROADWAY, WHITE PLAINS, NY, 10601

(21) Appl. No.: 10/380,973

(22) PCT Filed: Sep. 21, 2001
(86) PCT No.: PCT/NO01/00387

(30) Foreign Application Priority Data
Sep. 22, 2000 (NO) 20004770

(51) Int. Cl. G09G 5/00

(52) U.S. Cl. 345/169

(57) ABSTRACT

A means for a handheld functional apparatus having an operating device, where the apparatus either has a display screen, e.g., of the LCD type, integrated therein or has a communications link to a remote display screen. The operating device has a control element which via an interface is adapted to at least two-dimensionally control a cursor that is freely movable on the display screen in order to carry out at least one of the following operations: to move the cursor towards an optional one of several function icons, in order on actuating the control element to select an icon and thus an icon-related function in the apparatus; to navigate in a menu on the screen by using the cursor, to effect selection and confirmation of various menu options associated with apparatus functions; to open and close folders/files; to effect the carrying-out of apparatus functions; to handle the selection of numbers, symbols and letters, optionally via a keyboard displayed on the screen; and to manipulate or move at least some of the data or other information displayed on the screen at any time.

The present invention relates to a means for a handheld functional apparatus having an operating device, where the apparatus is in general approximately the same size as a human hand, and where the apparatus either has a display screen, e.g., of the LCD type, integrated therein or has a communications link to a remote display screen.

Such means are generally known from, for example, mobile telephones and remote control units for controlling sound equipment (e.g., stereo systems), TV sets, recording/playback equipment etc.

There is a growing tendency for such apparatuses to have an increasing number of functions, and the trend also appears to be towards having just one apparatus which is, for example, a combined personal computer (PC) and mobile telephone with all the connections and functions that this entails.

Very often each individual key located on such an apparatus is provided with a reference to the function the key is to operate.

However, in the case of handheld functional apparatuses it is becoming increasingly complicated to be able to carry out the necessary functions as it is not always easy to have a complete overview of the large number of function keys. In addition, apparatuses of this kind have over time progressively become multifunction apparatuses. An example of this are mobile telephones which have increasingly become mobile terminals in which a great number of applications are integrated.

There has therefore long been a desire to provide a solution that permits the handling of the functions to be performed by the apparatus to be carried out in an efficient and simple manner.

According to the invention, the means is characterised in that the operating device has a control element which via an interface is designed to at least two-dimensionally control a cursor that is freely movable on a display screen in order to carry out at least one of the following operations:

to move the cursor towards an optional one of several function icons, in order on actuating the control element to select an icon and thus an icon-related function in the apparatus;

to navigate in a menu on the screen by using the cursor;

to effect selection and confirmation of various menu options associated with apparatus functions;

to open or close folders/files;

to effect the carrying-out of apparatus functions;

to handle the selection of numbers, symbols and letters, optionally via a keyboard displayed on the screen; and

to manipulate or move at least some of the data or other information displayed on the screen at any time.

Additional embodiments of the means will be apparent from the attached patent claims, and from the following description with reference to the attached drawings.

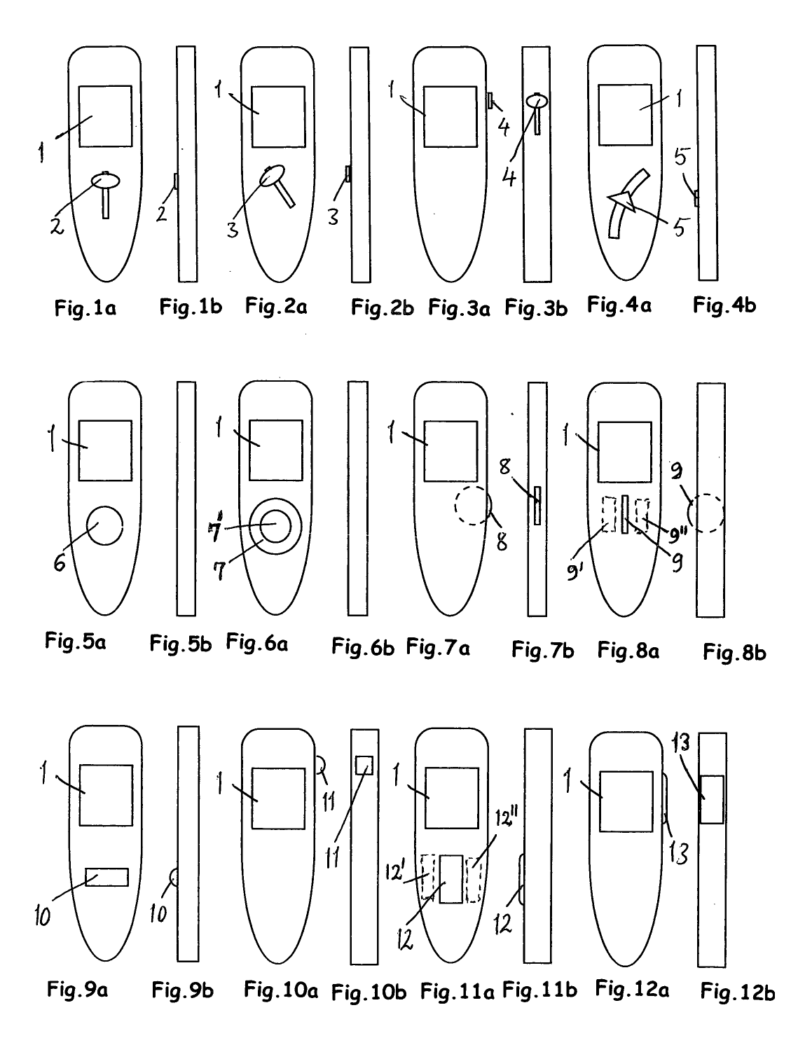

FIGS. 1-12 show twelve typical examples of a mobile telephone or similar apparatus having just one operating device.

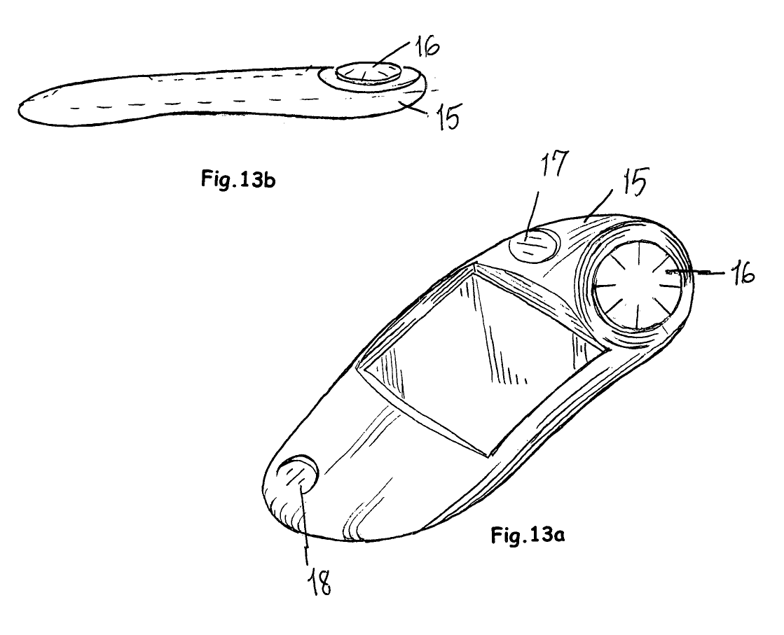

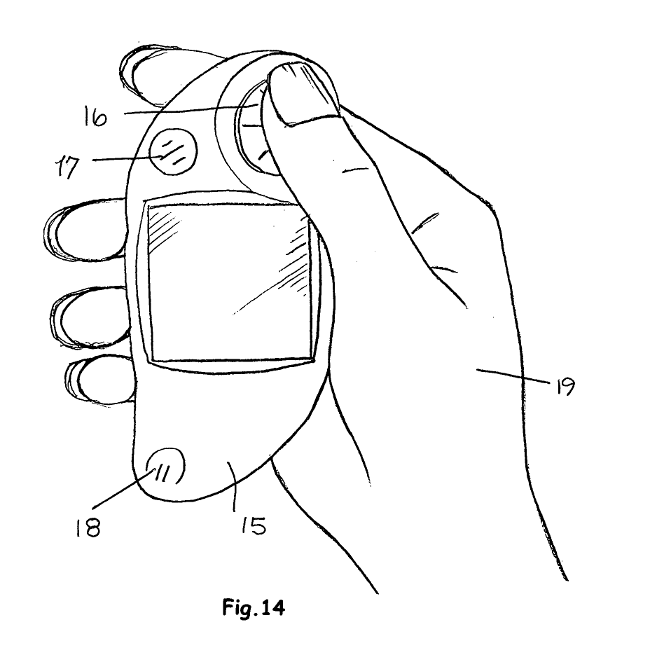

FIGS. 13a and b show in perspective and in side view respectively a functional apparatus such as a mobile telephone.

FIG. 14 shows how the apparatus in FIG. 13 can be held and operated using one and the same hand.

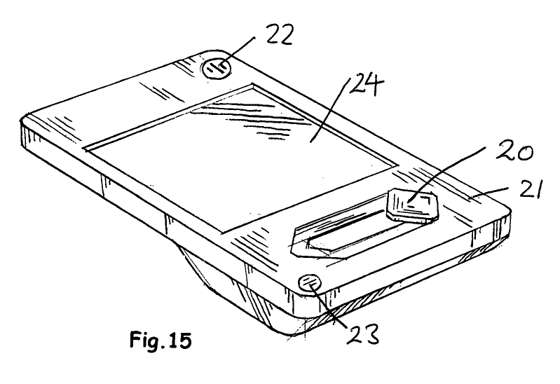

FIG. 15 shows an alternative solution for a functional apparatus such as a mobile telephone.

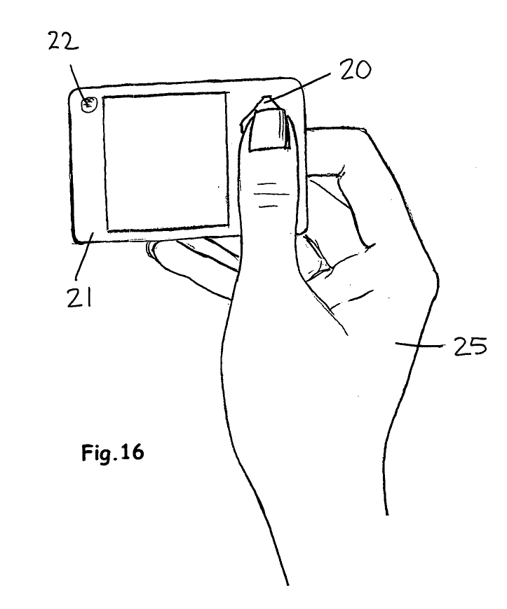

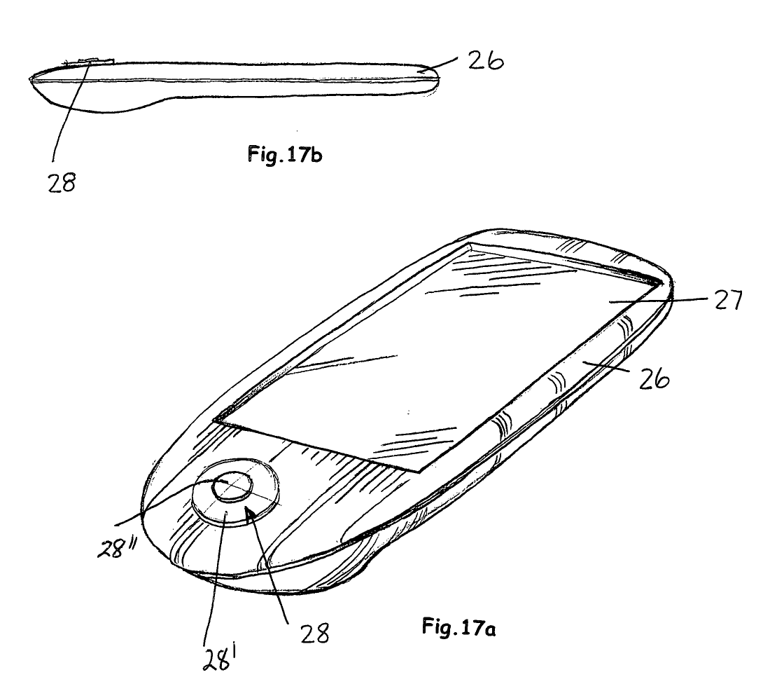

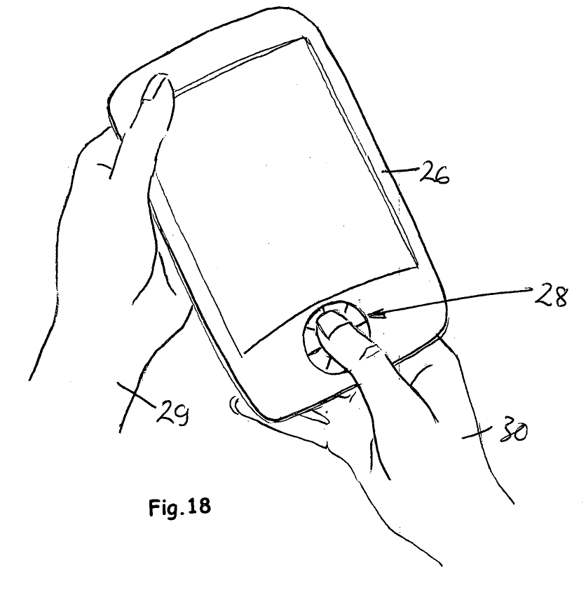

FIG. 16 shows how a functional apparatus of, for example, the type shown in FIG. 15 can be held and operated using one and the same hand.

FIGS. 17a and 17b show a functional apparatus that embraces products such as PDAs, mini PCs, communicators etc.

FIG. 18 shows how a functional apparatus, like that shown in FIG. 17, can be held and operated, for example, using two hands.

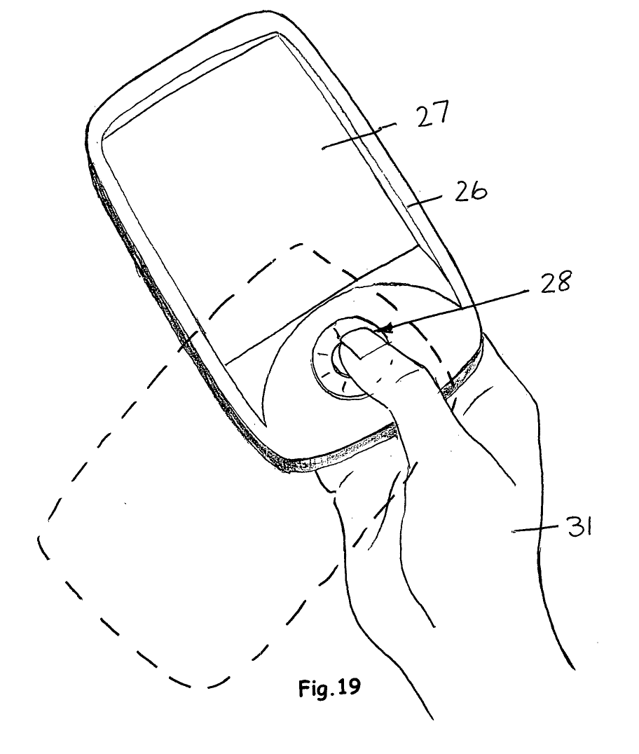

FIG. 19 shows how a functional apparatus as shown in FIG. 17 can be held and operated using one and the same hand.

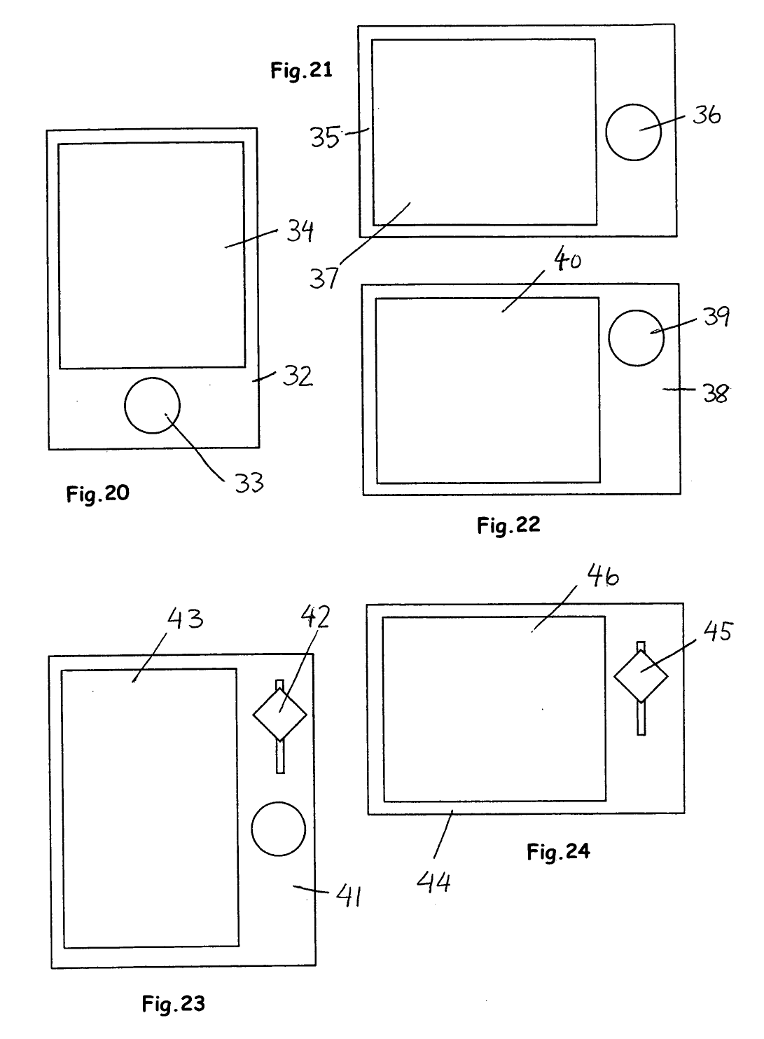

FIGS. 20-24 show five alternative locations of the operating device in connection with the use of an apparatus that requires a certain screen size, as for example a mini PC.

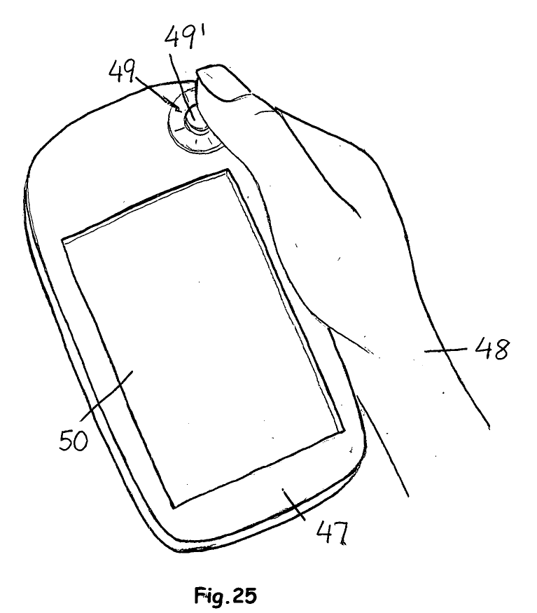

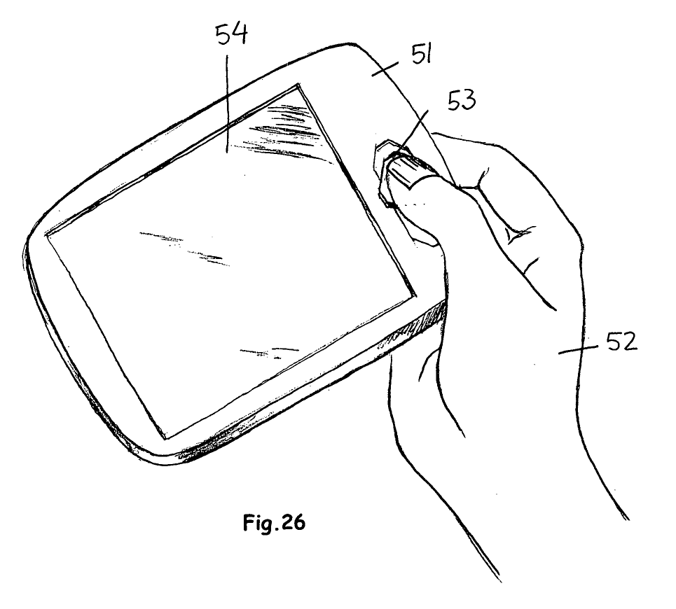

FIG. 25 shows an alternative solution of a functional apparatus that requires a large screen size and where the apparatus can be held and operated using one and the same hand.

FIG. 26 shows an alternative solution to that shown in FIG. 25 using a different type of operating device.

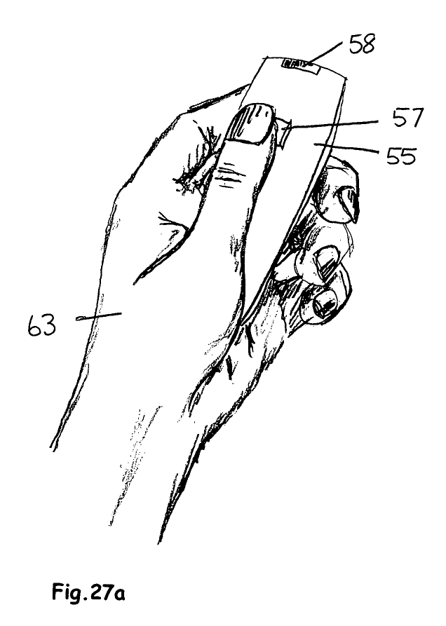

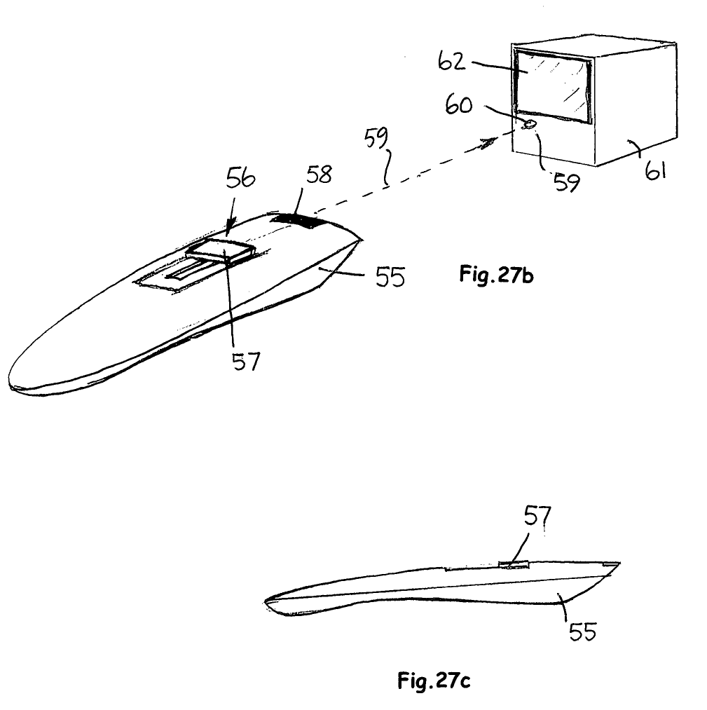

FIGS. 27a, 27b and 27c show respectively in a hand-operated position, in perspective and in side view, a functional apparatus provided with a multifunction operating device, FIG. 27a showing how the functional apparatus can be held and operated using one and the same hand.

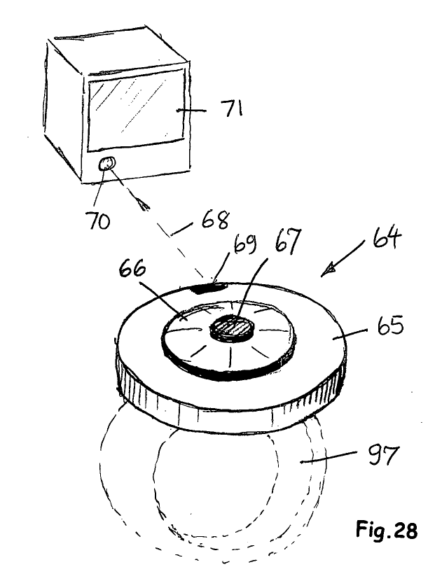

FIG. 28 shows an operating device for depression, rotation and cursor control.

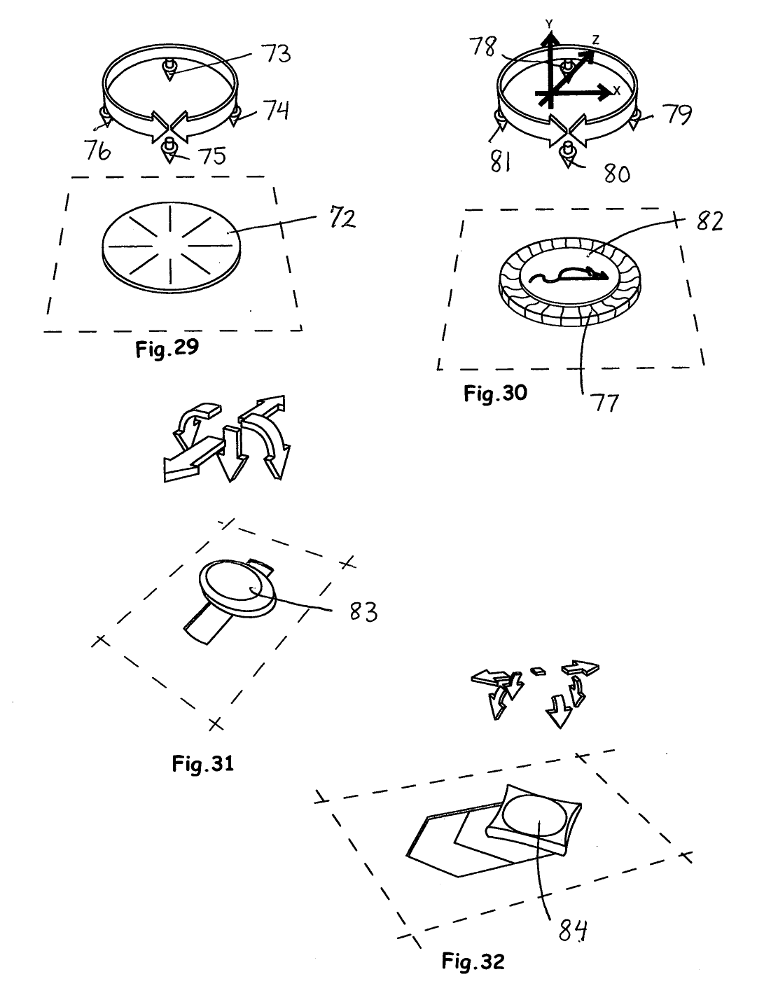

FIGS. 29-32 show alternative solutions of operating devices for use with the present means.

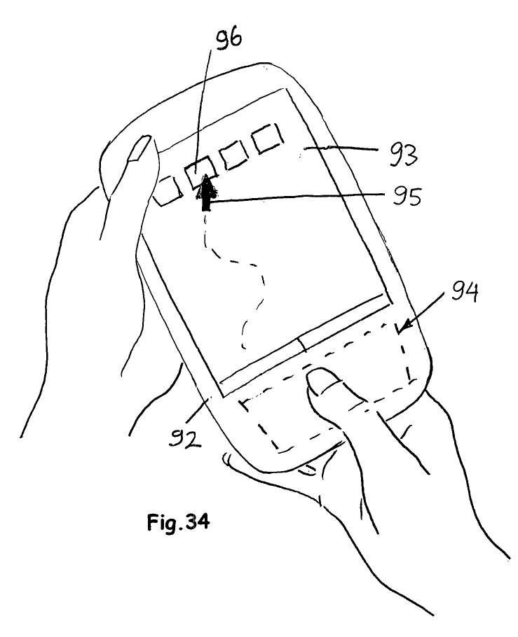

FIG. 33 shows a functional apparatus where the operating device permits a function control by depression, rotation and cursor control.

FIG. 34 shows a handheld functional apparatus, where the screen image shows an arrow for pointing functions, selection and navigation, but where the figure does not indicate any specific switch solution.

FIGS. 1-12 show for the respective figures, and as an example, the respective functional apparatuses in plan view and in side view.

FIGS. 1, 2, 3 and 4 show a functional apparatus having a display screen 1 and provided with operating devices which have a control element consisting of a stepwise movable sliding key with a tilting and/or depression function. In FIGS. 1, 2, 3 and 4 said control elements are indicated by means of the respective reference numerals 2, 3, 4, and 5. In FIG. 1 it will be seen that the sliding key 2 has a direction of travel in the longitudinal direction of the functional apparatus and is located on its upper side. The same applies to the embodiment in FIG. 2 where, however, the sliding key is oblique in relation to the longitudinal axis of the functional apparatus.

In the embodiment shown in FIG. 3 the sliding key 4 is located on a side portion of the functional apparatus.

In FIG. 4 the sliding key is designed to move along a curved path.

The embodiment shown in FIG. 5 has a stepwise rotatable key 6 having depression functions and/or a centre position deviation function.

In FIG. 6 the operating device consists of two control elements which are formed of a stepwise rotatable ring member 7 having depression functions and which surrounds a non-rotatable key which has a centre position deviation function.

The embodiment in FIG. 7 shows a rotatable wheel which is preferably tiltable sideways and where the wheel is located in a side portion of the functional apparatus.

FIG. 8 shows a variant where the wheel is indicated by the reference numeral 9 and projects up from a front plate of the functional apparatus. In this case too, the rotatable wheel 9 will preferably be tiltable sideways, thereby enabling control of the selection of, for example, three function options.

FIG. 9 shows a rotatable roller 10 located in a front face of the functional apparatus and where the roller is preferably tiltable sideways. A similar solution is indicated by the reference numeral 11 in FIG. 10, where, however, the roller is located on a side portion of the functional apparatus.

FIG. 11 indicates an endless belt-based operating device control element 12 located on the front face of the functional apparatus, and FIG. 12 shows a similar switch 13 located on a side portion of the functional apparatus.

FIG. 13 a shows an implementation of the present invention in connection with, for example, a mobile telephone 15, which in the chosen example has a stepwise rotatable key having depression functions and/or a centre position deviation function. A key or control element 16 of this kind will be capable of controlling the operation of all the functions of the functional apparatus. This is effected in that the control element 16 permits browsing in menu functions and menu lists and the selection of functions and functional details therein. In FIG. 13, the loudspeaker of the mobile telephone, for example, is indicated by the reference numeral 17, and its microphone by the reference numeral 18. In FIG. 14 it is shown how the functional apparatus as indicated in FIG. 13 can be held and operated by one and the same hand 19. Of course, the solution shown in FIGS. 13 and 14 can also be used for functional apparatuses other than a mobile telephone, as for instance a calculator or other small, fairly simple functional apparatuses.

FIG. 15 shows an alternative solution where the operating device consists of a stepwise movable sliding key 20 located on a front side of the functional apparatus 21. The receiver and microphone on the functional apparatus are respectively indicated by the reference numerals 22 and 23. The display screen incorporated in the functional apparatus is indicated in this figure by the reference numeral 24. Although the embodiment in FIG. 15 is intended in particular to be used in connection with a mobile telephone, it will be appreciated that the solution can also be used for many other types of handheld functional apparatuses.

FIG. 16 shows how the functional apparatus shown in FIG. 15 can be easily held and operated by one and the same hand 25.

FIG. 17 shows a functional apparatus 26 having display screen 27 and operating device 28. In this case, the operating device may consist of, for example, a stepwise rotatable ring member 28′ with depression functions which surrounds a non-rotatable key 28″ which may be provided with a centre position deviation function. The centre position deviation function principle is essential in connection with the control of a cursor on a display screen, such as the display screen 27.

FIG. 18 shows how a functional apparatus, such as that shown in FIG. 17, can be held, in the illustrated example by using two hands 29, 30, in the way that functional apparatuses are held very often. By using two hands, the user will not be so completely limited to having to use just his thumb, but can also choose other fingers, such as an index finger.

FIG. 19 shows how the functional apparatus shown in FIG. 17 can be held and operated using one and the same hand 31. Several different positions of the functional apparatus in relation to the user's hand will also be possible.

FIGS. 20-22 and FIGS. 23-24 show respectively alternative switch locations in connection with the use of a rotary switch and a sliding switch when utilising a functional apparatus requiring a certain screen size such as a mini PC. In FIGS. 20-24, the functional apparatus is indicated by the respective reference numerals 32, 35, 38, 41 and 44, and in FIGS. 20-22 the control element is indicated by the respective reference numerals 33, 36 and 39. As mentioned, a control element of this kind can, for example, be chosen to be a stepwise rotatable key having depression functions and/or a centre position deviation functions. In FIGS. 23 and 24 the control element consists of a stepwise movable sliding key having a tilting and/or depression function. This sliding key in FIGS. 23 and 24 is indicated by the reference numeral 45. In addition, in FIGS. 20-24 the actual display screen is indicated by the respective reference numerals 34, 37, 40, 43 and 46.

FIG. 25 shows an alternative solution of the functional apparatus requiring a large screen size and where the functional apparatus 47 is designed to be held and operated by using one and the same hand 48, the operating device in this case being, in a non-limitative manner, shown as a stepwise rotatable ring member 49 having depression functions and which surrounds a non-rotatable key 49′ which has a centre position deviation function. In FIG. 25 the display screen is indicated by the reference numeral 50.

FIG. 26 shows an alternative solution to that apparent from FIG. 25, where the functional apparatus is indicated by the reference numeral 51 and can be held and operated using one and the same hand 52 by using a control element 53 in the form of a stepwise movable sliding key having a tilting and/or depression function. The display screen of the functional apparatus is indicated by the reference numeral 54.

FIG. 27 shows a functional apparatus 55 which has implemented a multifunction operating device 56, in the illustrated example consisting of a stepwise movable sliding key having a tilting and/or depression function, indicated by the reference numeral 57. However, the operating device 56 can easily be replaced by other solutions, such as a stepwise rotatable key having depression functions and/or a centre position deviation function, or, for example, a stepwise rotatable ring member having depression functions which surrounds a non-rotatable key which has a centre position deviation function. As is evident from FIG. 27, the functional apparatus 55 does not have its own display screen, but is equipped with a signal transmitter 58 for communicating via a signal route 59 with a signal receiver 60 in a display apparatus 61 which has a display screen 62. By manipulating the operating device 56, the user will immediately receive an acknowledgement message via the display screen 62, so that in this case too it is not necessary to have any specific function indications on the actual operating device. The functional apparatus 55 can expediently be used for remote control of other applications that are equipped with some form of display screen. In this connection, conceivable example are a TV set, PC, music centre, film projector, overhead projector, projection apparatus etc, and the functional apparatus would have to have in-built technology for remote transmission of signals. In FIG. 27a it will easily be seen that the functional apparatus 55 can be held and operated using one and the same hand 63. Naturally, this means that the carrying-out of functions can take place in a significantly simpler and faster manner than has hitherto been usual.

FIG. 28 shows an operating device 64 that is mounted on a base 65 and has a stepwise rotatable ring member 66 having specific depression functions and which surrounds a non-rotatable key 67 which however has a centre position deviation function, so as to facilitate control a cursor on a display screen in order to position it on a desired function, as represented by a function icon. An operating device of this kind can, for example, communicate wirelessly, as indicated by the reference numeral 68 via a transmitter 69 and a receiver 70 in connection with a display 71. An operating device 64 of this kind can, for example, be placed in proximity of a computer and communicate with the computer via said wireless connection 68, but it is also possible to place such an operating device 64, for example, on a finger to facilitate control of the device.

To explain in more detail a part of the control elements intended for use in connection with that illustrated and described, a stepwise rotatable key 72 having depression functions, for example, at four depression points 73, 74, 75 and 76, is shown in FIG. 29. A rotatable key of this kind can, as an alternative to the said depression points 73-76, be equipped with a centre position deviation function or have such a function as a supplement.

FIG. 30 shows a stepwise rotatable ring member 77 having depression functions as indicated by the reference numerals 78-81 and which surrounds a non-rotatable key 82 which has a centre position deviation function, as indicated by the coordinates at the top of FIG. 30.

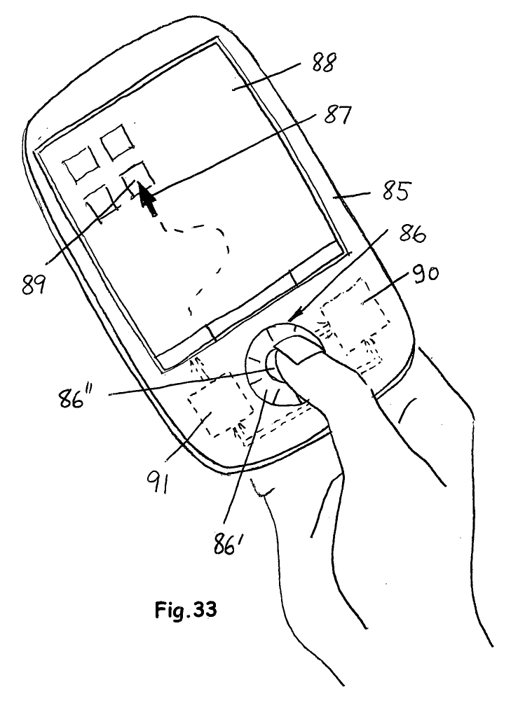

FIG. 31 shows a stepwise movable sliding key 83 having sideways tiltability and depression function. In the solution shown in FIG. 32 the stepwise movable sliding key is indicated by the reference numeral 84. The control element or key 84 in this case is tiltable to the sides and forwards and backwards, in addition to be being centrally depressible, so that in reality for each step position of the control element 84 there are five switch selection options.

That illustrated and described thus far is typically used when the operating device has a control element which via an interface is designed to at least two-dimensionally control a cursor that is freely movable on a display screen in order to carry out one or more operations, such as moving the cursor towards an optional one of several function icons, in order by actuating the control element to choose an icon and thus an icon-related function in the apparatus.

This is illustrated in more detail in FIG. 33, where the functional apparatus is indicated by the reference numeral 85 and where the operating device is indicated by the reference numeral 86. In the illustrated example, the operating device consists of a stepwise rotatable ring member 86′ having depression functions and where the ring member 86′ surrounds a non-rotatable key 86″ which has a centre position deviation function. The key 86′ is essential for the control a cursor 87 on the display screen 88 of the functional apparatus 85, so as to be able to move the cursor 87 towards a chosen icon, such as the icon 89. An interface 90 communicates with the operating device 86 and also communicates with a microprocessor 91 which in turn controls the display on the display screen 88.

It will immediately be understood that although the operating device 86 is shown in a specific embodiment in FIG. 33, other embodiments of the operating device are possible. What is essential, however, is that the functional apparatus can be held and operated using one hand. Of course, it will also be possible, as shown in FIG. 34, to use both hands, the second hand in such a case merely having a support function, such as when the user is standing in an unstable position or it does not feel safe to just hold the apparatus with one hand.

In FIG. 34 the functional apparatus is generally indicated by the reference numeral 92 and has a display screen 93 and the operating device control element is generally and symbolically indicated by the reference numeral 94 and is designed to control a cursor 95 so as to move it on the display screen, for example, in order to select one of several icons 96. The operating device and its control element can thus be any one of the types illustrated and described in the above. It is also conceivable in this connection that the control element at least in some of the embodiments illustrated in, for example, FIGS. 1-5, 13-28, 29-32, is equipped with a capacitance sensor in connection with the contact face of the control element. Furthermore, it is conceivable that the control element, for example, may consist of a capacitance-sensing touch pad.

Alternatively, it is possible to use a capacitance-sensing touch pad or contact face. In the solutions shown, for example, in FIGS. 8 and 11, it is conceivable that the control element 9 need not necessarily be tiltable sideways but can cooperate with switch keys 9′, 9″ located either side thereof In the solution shown in FIG. 11, the key 12 can have a switch key 12′, 12″ on either side thereof. The switch 12 can, for example, be a sliding switch or a linearly movable centre position deviation key. It is also conceivable that the key 12 is related to a tilt switch.

The switch solution shown, for example in FIG. 1 and in FIG. 31 and FIG. 32 will initially serve as an x/y direction switch. However, it will be appreciated that this could also be is related to an x/y/z related switch function where, for example, central depression can cause movement in, for example, the z plane, i.e., to be able to move between different menu images which emerge and lie in planes over one another at right angles on the display screen.

It will also be understood that the switches that are shown, for example, in connection with FIGS. 5 and 6 and FIGS. 29 and 30 could easily be adapted to the x/y or x/y/z function.

Although numerous examples of operating devices having a control element are conceivable, there will also be certain cases where it may be relevant to combine several different ones of the illustrated operating devices in order to achieve even greater flexibility of control.

As outlined in FIG. 28, the operating device, as indicated by the reference numeral 64 may optionally be fastened to a ring 97, so that the operating device can be worn on a finger and controlled by another finger on the same hand.

1. A handheld functional apparatus having an operating device, where the apparatus is in general approximately the same size as a human hand, and where the apparatus has either a display screen integrated therein or a communications link to a remote display screen, the operating device having a control element operable by a single finger on a user hand holding or supporting the apparatus, said control clement operable for at least two-dimensionally to control a cursor or marker movable on the display screen in order to execute at least one functional operation,
wherein said control element through manipulation thereof eanables at least one of the following operations to be executed:
a) movement of the cursor or marker towards an optional one of several menu function icons and election of an icon and thus an icon-related function in the apparatus through actuation of the control element,
b) movement of the cursor for navigation in a menu displayed on the screen, and
c) election and confirmation of various menu options associated with apparatus functions to effect such apparatus function,
wherein said operation of a) or c) includes one or more of: opening or closing folders or files, handling a selection of numbers, symbols and letters, and manipulating data related to at least some information displayed at any time, and
wherein said control element is elected from type group of:
d) a stepwise movable sliding key having tilting and depression functions;
e) a stepwise rotatable key having depression functions or a centre position deviation function;
f) a stepwise rotatable key having depression functions and a position deviation function;
g) a stepwise rotatable ring member having depression functions and which surrounds a non-rotatable key providing additional deviation function,
h) a rotatable wheel or roller that is sideways tiltable;
i) a rotatable wheel or cylinder having keys located at either side thereof

2. An apparatus as disclosed in claim 1, wherein
that the operating device is in wireless connection with a remote display.

3. An apparatus according to claim 1, wherein the non-rotatable key of the type g) control element is provided a centre position deviation function

4. An apparatus as disclosed in claim 1, wherein the apparatus is designed to be supported by a palmar finger region of the user hand and retainable between the forefinger and a forward thumb region of the hand at a location of the control element of the operating device.

5. Use of a handheld electronic apparatus having:
a multifunctional control element elected from the group of:
a) a stepwise movable sliding key having tilting and depression functions;
b) a stepwise rotatable key having depression functions or a centre position deviation function;
c) a stepwise rotatable key having depression functions and a centre position deviation function;
d) a stepwise rotatable ring member having depression functions and which surrounds a non-rotatable key,
e) a rotatable wheel or roller that is sideways tiltable;
f) a rotatable wheel or cylinder having keys located at either side thereof; and
a display associated with the apparatus for interactively by means of the control element carrying out at least one of the following operations:
g) moving the cursor towards an optional one of several menu function icons and electing an icon and thus an icon-related function in the apparatus through actuation of the control element,
